(19) United States
(12) Patent Application Publication
(10) Pub. No.: US 2012/0162080 A1
(43) Pub. Date: Jun. 28, 2012

(54) DUAL-SCREEN NOTEBOOK COMPUTER WITH KEYBOARD

(75) Inventor: Xiang CAO, Shenzhen City (CN)

(73) Assignees: HON HAI PRECISION INDUSTRY CO., LTD., Tu-Cheng (TW); HONG FU JIN PRECISION INDUSTRY(ShenZhen) Co.,LTD., Shenzhen City (CN)

(21) Appl. No.: 13/216,169

(22) Filed: Aug. 23, 2011

(30) Foreign Application Priority Data
Dec. 24, 2010 (CN) 201010604186.3

(51) Int. Cl. G06F 3/041

(52) U.S. Cl. 345/168

(57) ABSTRACT

An exemplary dual-screen notebook computer includes a host, a main screen and an input panel mounted on the host. The main screen is pivotally connected with one side of the host for displaying data and programs thereon. The input panel includes a touch screen functioning as a virtual keyboard at one major side thereof and a keyboard at an opposite major side thereof. The input panel is rotatable to selectively change orientations of the touch screen and the keyboard such that either the input panel is mounted on the host with the touch screen exposed for use or the input panel is mounted on the host with the keyboard exposed for use.

### BACKGROUND

1. Technical Field

The disclosure generally relates to notebook computers, and more particularly to a dual-screen notebook computer.

2. Description of the Related Art

Notebook computers have been very popular in the marketplace in recent years, and have become a mainstream item in many computer markets worldwide. A dual-screen notebook computer, which includes a display screen and a touch screen, is also becoming another staple in the computer market. The display screen is pivotally connected with a host (main body) by conventional means, for displaying data and programs. The touch screen is incorporated in the host and functions as a virtual keyboard, allowing users to enter characters by handwriting on the touch screen. The dual-screen notebook computer including the touch screen in handwriting mode is beneficial for special requirements, such as in graphic design, web editing and so on. However, the touch screen has limited benefits for common daily use. Typically, for common daily use, a user is required to connect a computer mouse to the dual-screen notebook computer. This is somewhat inconvenient.

What is called for, then, is a notebook computer which can overcome the limitations described.

### BRIEF DESCRIPTION OF THE DRAWINGS

FIG. 1 is a schematic, assembled view of a dual-screen notebook computer according to an exemplary embodiment of the present disclosure, wherein the dual-screen notebook computer includes a host, a main screen, and an input panel mounted in the host, showing a touch screen of the input panel exposed for use.

FIG. 2 is similar to FIG. 1, but showing the input panel rotated out from the host, and in the process of being further rotated and repositioned back into the host.

FIG. 3 is similar to FIG. 1, but showing the input panel mounted in the host such that a keyboard of the input panel is exposed for use.

### DETAILED DESCRIPTION

Reference will now be made to the figures to describe the present dual-screen notebook computer in detail.

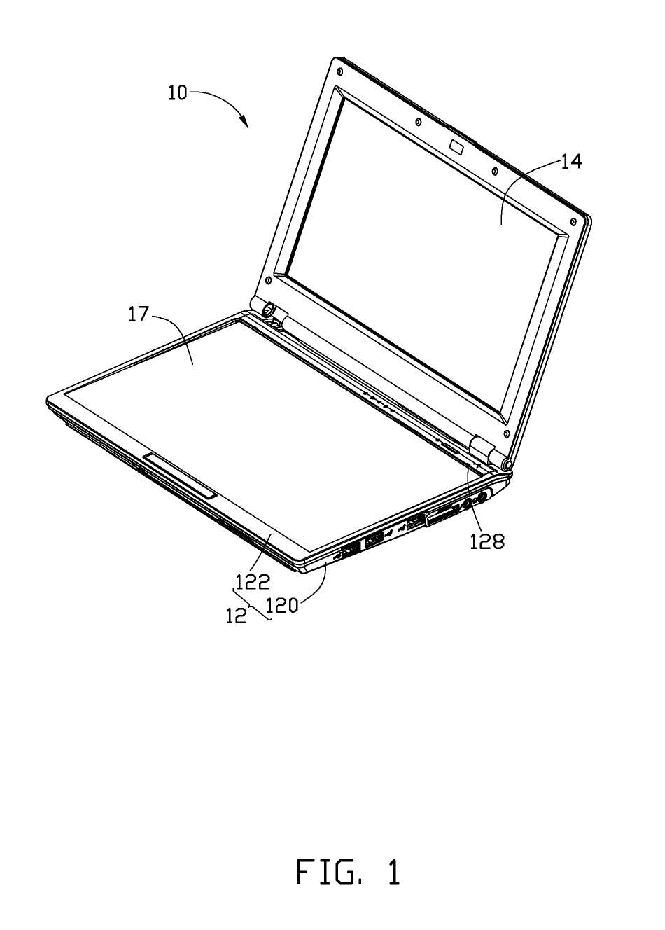

Referring to FIG. 1, a dual-screen notebook computer 10 according to an exemplary embodiment of the present disclosure includes a host (main body) 12, a main screen 14 pivotally connected with one side of the host 12, and an input panel 17 mounted on the host 12.

The main screen 14 is a common liquid crystal display for displaying data and programs of the dual-screen notebook computer 10 thereon.

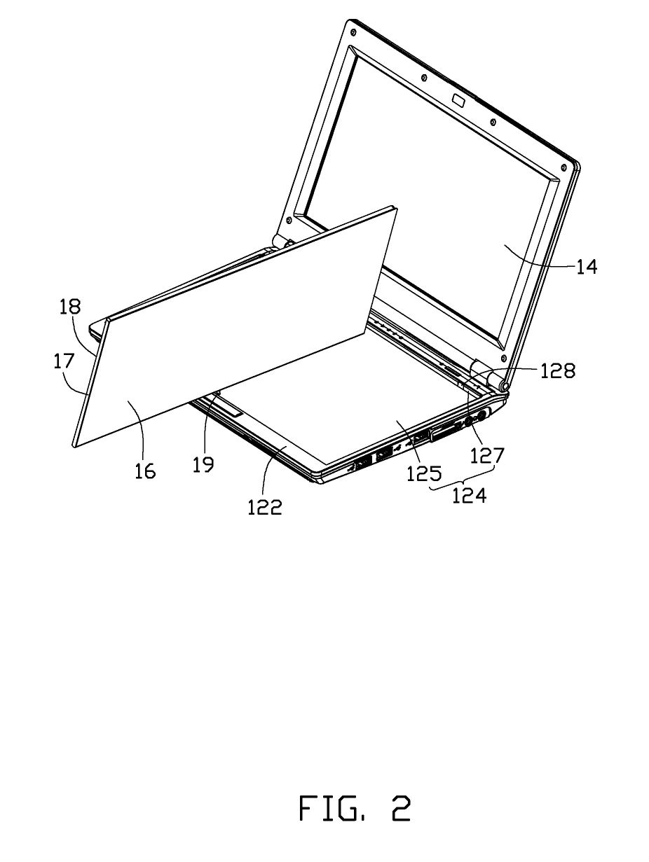

The host 12 is rectangular in shape, and includes a base 120 and a cover 122 covering the base 120. Referring also to FIG. 2, the cover 122 defines a rectangular receiving room 124 recessed from a top surface thereof toward a bottom surface thereof. The receiving room 124 has a size substantially equal to that of the input panel 17, whereby the input panel 17 can be fittedly received in the receiving room 124. The base 120 includes a supporting wall 125 located lower than the top surface of the cover 122, and four side walls 127 extending perpendicularly upward from the supporting wall 125. The supporting wall 125 and the side walls cooperatively define the receiving room 124. Two cutouts 128 are defined in two opposite ends of one of the side walls 127 that is located adjacent to the main screen 14, respectively. The cutouts 128 communicate with the receiving room 124. Each of the cutouts 128 is configured for allowing a user's finger to access an edge of the input panel 17 when the input panel 17 is seated in the receiving room 124. Thereby, the user can lift up the edge of the input panel 17 to pull the input panel 17 out from the receiving room 124.

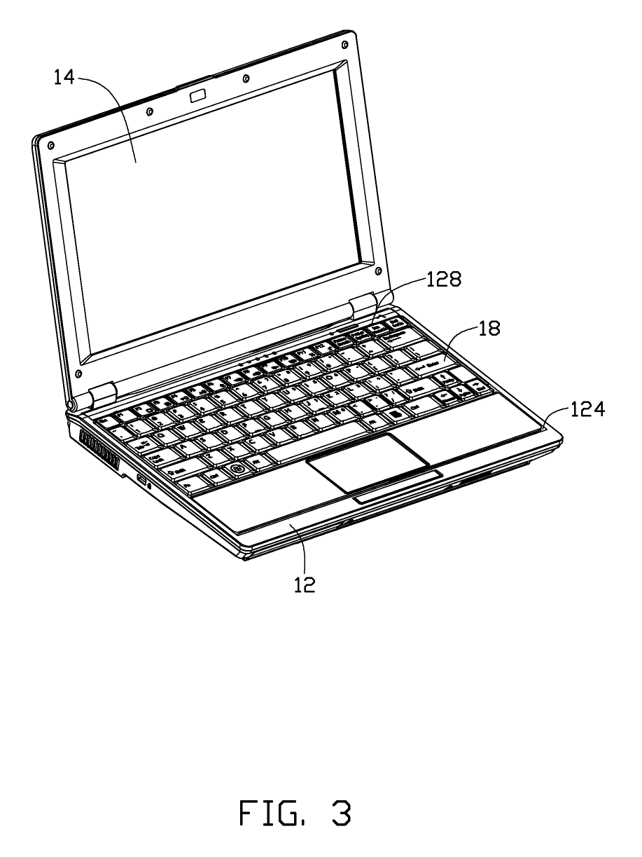

That is, the input panel 17 is removably received in the receiving room 124 of the host 12. A pivot axle 19 extends from a middle portion of one of the side walls 127 which is farthest away from the main screen 14. The pivot axle 19 has a bottom end connected with the side wall 127, and a top end opposite to the bottom end. The pivot axle 19 can be changed between a horizontal state (FIGS. 1 and 3) in which the pivot axle 19 is wholly received in the receiving room 124, and a vertical state (FIG. 2) in which the top end of the pivot axle 19 is perpendicular to the cover 122 with the top end protruded out of the receiving room 124. The input panel 17 connects the host 12 via the pivot axle 19, and is rotatable about the pivot axle 19.

The input panel 17 electrically connects a mainboard (not shown) of the host 12 via a data line extended through the side wall 127 that is farthest away from the main screen 14. In this embodiment, the pivot axle 19 defines an axial hole at a central portion thereof, for receiving the data line therein.

Referring also to FIG. 3, the input panel 17 includes a touch screen 16 functioning as a virtual keyboard at one major side thereof, and a keyboard 18 at the other major side thereof opposite to the touch screen 16. The input panel 17 can be received in the receiving room 124 of the host 12 in a first state in which the touch screen 16 faces upward and the keyboard 18 faces downward, or in a second state in which the keyboard 18 faces upward and the touch screen 16 faces downward.

When the input panel 17 is changed from one of the first and second states to the other state, the input panel 17 is firstly drawn out of the receiving room 124. In this process, the edge of the input panel 17 is lifted up and moved away from the cover 122, with the pivot axle 19 changed to the vertical state. Then the input panel 17 is rotated about the pivot axle 19 180 degrees to change the directions in which the major sides of the input panel 17 face. Finally, the input panel 17 is lowered back into the receiving room 124. The touch screen 16, when positioned for use, functions as the virtual keyboard that allows the user to enter characters by handwriting on the touch screen 16. Thereby, the user is able to meet special requirements, such as in graphic design, web editing, and so on. The keyboard 18, when positioned for use, can meet common daily requirements of the user.

In summary, the input panel 17 includes the touch screen 16 and the keyboard 18 at the two opposite major sides thereof. A user can choose the touch screen 16 or the keyboard 18 according to different requirements, simply by rotating the input panel 17. Thus, the dual-screen notebook computer 10 can realize the functions of a keyboard and a virtual keyboard at any time, providing much convenience.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A dual-screen notebook computer, comprising:
a host;
a main screen pivotally connected with one side of the host for displaying data and programs thereon; and
an input panel mounted on the host, the input panel comprising a touch screen functioning as a virtual keyboard at one major side thereof and a keyboard at an opposite major side thereof, the input panel being rotatable to selectively change orientations of the touch screen and the keyboard such that either the input panel is mounted on the host with the touch screen exposed for use or the input panel is mounted on the host with the keyboard exposed for use.

2. The dual-screen notebook computer of claim 1, wherein the host comprises a base and a cover covering the base, and the cover defines a receiving room for receiving the input panel therein.

3. The dual-screen notebook computer of claim 2, further comprising a pivot axle at one side of the receiving room, the pivot axle connected with the input panel.

4. The dual-screen notebook computer of claim 2, wherein the input panel is rotatable about the pivot axle.

5. The dual-screen notebook computer of claim 3, wherein the pivot axle is movable between a horizontal state in which the pivot axle is wholly received in the receiving room and a vertical state in which the pivot axle is perpendicular to and protrudes out of the receiving room.

6. The dual-screen notebook computer of claim 5, wherein the cover comprises a supporting wall and a plurality of side walls extending upward from the supporting wall, and the pivot axle located at a middle of one of the side walls that is farthest away from the main screen.

7. The dual-screen notebook computer of claim 6, wherein a cutout is defined at one of the side walls that is located adjacent to the main screen, and the cutout communicates with the receiving room for allowing a user's finger to access an edge of the input panel via the cutout.

8. A dual-screen notebook computer, comprising:
a host defining a receiving room therein;
a main screen pivotally connected with one side of the host for displaying data and programs thereon; and
an input panel mounted to the host and removably received in the receiving room, the input panel comprising a touch screen functioning as a virtual keyboard at one side thereof and a keyboard at an opposite side thereof, wherein the input panel can be selectively changed between a first state in which the input panel is received in the receiving room with the touch screen facing upward and the keyboard facing downward, and a second state in which the input panel is received in the receiving room with the keyboard facing upward and the touch screen facing downward.

9. The dual-screen notebook computer of claim 8, wherein the host comprises a pivot axle located at one side of the receiving room, the input panel connected with the pivot axle and rotatable about the pivot axle.

10. The dual-screen notebook computer of claim 9, wherein when the input panel is at the first state or the second state, the pivot axle is at a horizontally state in which the pivot axle is wholly received in the receiving room, and when the input panel is changed from one of the first and second states to the other state, the pivot axle is at a vertical state in which the pivot axle is perpendicular to and protrudes out of the receiving room.

11. The dual-screen notebook computer of claim 8, wherein the host defines two cutouts at one side of the receiving room, the cutouts communicated with the receiving room, for allowing a user's finger to access an edge of the input panel via the cutouts.

12. The dual-screen notebook computer of claim 8, wherein the host comprises a base and a cover covering the base, the receiving room being defined in the cover.

13. A dual-screen notebook computer, comprising:
a host;
a main screen pivotally connected with one side of the host for displaying data and programs thereon; and
an input panel mounted in the host and attached to the host by a pivot axle, the input panel comprising a touch screen functioning as a virtual keyboard at one major side thereof and a keyboard at an opposite major side thereof, the input panel being demountable, rotatable and remountable to selectively change orientations of the touch screen and the keyboard such that either the input panel is mounted in the host with the touch screen exposed for use or the input panel is mounted in the host with the keyboard exposed for use.
